(19) United States
(12) Patent Application Publication
(10) Pub. No.: US 2013/0274639 A1
(43) Pub. Date: Oct. 17, 2013

(54) Flexible negative pressure cup

(71) Applicant: Cunyun Fang, Shenzhen (CN)

(72) Inventor: Cunyun Fang, Shenzhen (CN)

(21) Appl. No.: 13/997,150

(22) PCT Filed: Dec. 21, 2011
(86) PCT No.: PCT/CN11/84386

§ 371 Date: Jun. 21, 2013

(30) Foreign Application Priority Data
Dec. 21, 2010 (CN) 201010598685.6

(51) Int. Cl. A61H 7/00

(52) U.S. Cl. CPC A61H 7/00
USPC 601/14

(57) ABSTRACT

A flexible negative pressure cup includes a body case having a boxlike shape, a flexible cup body, an air extracting pump, an inlet valve and a control box. The lower portion of the body case is connected with the upper portion of the flexible cup body for forming an air chamber between the bottom wall of the body case and the flexible cup body. The middle portion of the bottom of the flexible cup body is upwardly protruded. Two downwardly protruded annular buds are respectively formed at two end portions of the bottom of the flexible cup body. An air hole is provided on the bottom wall of the body case. The air hole is communicated with the air extracting pump and the inlet valve located outside the body case by a flexible tube. The control box is connected with the air extracting pump and the inlet valve.

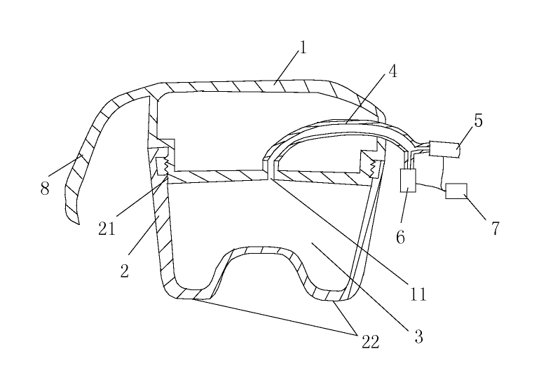

### BACKGROUND OF THE PRESENT INVENTION

1. Field of Invention The present invention relates to a health care appliance, and more particularly to a flexible negative pressure cup for enlarging breast.

2. Description of Related Arts

Existing breast enhancement products are suction transparent plastic cups which are set outside of the breast. They have the shortcomings as below. While using, the negative pressure within the transparent plastic cup set outside of the breast is very large and unchanged. The transparent cup mouth acts on the root of the breast, so that the mutation of the negative pressure is generated. A lot of pressure and tension occur at the position where the negative pressure is mutated, which will cause different degrees of damage to the breast and the root of the breast after a long time.

### SUMMARY OF THE PRESENT INVENTION

An object of the present invention is to provide a flexible negative pressure cup, which has no mutation of the negative pressure at the root of the breast for protecting the breast, is capable of greatly increasing the secretion level of hormone for improving the breast enlargement effect, and also has some efficacy of treatment and recovery for impotence and other sexual dysfunctions.

Accordingly, in order to accomplish the above object, the present invention provides a flexible negative pressure cup, comprising a body case, a flexible cup body, an air extracting pump, an inlet valve and a control box, wherein the body case has a boxlike shape, a lower portion of the body case is connected with an upper portion of the flexible cup body for forming an air chamber between a bottom wall of the body case and the flexible cup body, a middle portion of a bottom of the flexible cup body is upwardly protruded, two downwardly protruded annular buds are respectively formed at two end portions of the bottom of the flexible cup body, an air hole is provided on the bottom wall of the body case, the air hole is communicated with the air extracting pump and the inlet to valve which are located outside the body case by a flexible tube, the control box is connected with the air extracting pump and the inlet valve.

Preferably, the lower portion of the body case is threadedly connected with the upper portion of the flexible cup body.

Preferably, a sealing ring is provided between the lower portion of the body case and the upper portion of the flexible cup body.

Preferably, the flexible cup body is made of rubber or silica gel.

Preferably, the flexible negative pressure cup further comprises a hand support connected with the body case, which is convenient for grasping the flexible negative pressure cup while using.

The working principle of the present invention is described as follows.

While using, the flexible cup body is attached to the breast, the control box controls the alternate frequency of the gas exhaust of the air extracting pump and the gas admission of the inlet valve for generating the varying negative pressure in the air chamber whose frequency can be adjusted at any moment. With the increase and decrease of the negative pressure, the annular buds at the bottom of the flexible cup body will respectively move up and down along the breasts for generating the dynamic negative pressure massage. Repeat the operation as mentioned above.

Compared with the prior art, the present invention has some beneficial effects as follows. Firstly, due to the dynamic negative pressure massage to the breasts from the annular buds at the bottom of the flexible cup body, the negative pressure cycle which moves up and down is produced for increasing the secretion level of hormone, thus improving the breast enlargement effect, and also having some efficacy of treatment and recovery for impotence and other sexual dysfunctions. Secondly, the flexible negative pressure cup of the present invention is convenient for disassembly, cleaning and using.

These and other objectives, features, and advantages of the present invention will become apparent from the following detailed description, the accompanying drawings, and the appended claims.

### BRIEF DESCRIPTION OF THE DRAWINGS

The drawing is a perspective view of a flexible negative pressure cup according to a preferred embodiment of the present invention.

In the drawing, 1: body case; 11: air hole; 2: flexible cup body; 21: sealing ring; 22 annular bud; 3: air chamber; 4: flexible tube; 5: air extracting pump; 6: inlet valve; 7: control box; 8: hand support

### DETAILED DESCRIPTION OF THE PREFERRED EMBODIMENT

The present invention is further explained in detail with the accompanying drawings.

Referring to the drawing, a flexible negative pressure cup according to a preferred embodiment of the present invention is illustrated, wherein the flexible negative pressure cup comprises a body case 1, a flexible cup body 2, an air extracting pump 5, an inlet valve 6 and a control box 7. The body case 1 has a boxlike shape. A lower portion of the body case 1 is connected with an upper portion of the flexible cup body 2, thus forming an air chamber 3 between a bottom wall of the body case 1 and the flexible cup body 2. A middle portion of a bottom of the flexible cup body 2 is protruded upwardly. Two downwardly protruded annular buds 22 are respectively formed at two end portions of the bottom of the flexible cup body 2. The bottom wall of the body case 1 has an air hole 11. The air hole 11 is communicated with the air extracting pump 5 and the inlet valve 6 which are located outside the body case 1 by a flexible tube 4. The control box 7 is connected with the air extracting pump 5 and the inlet valve 6 for controlling them.

The lower portion of the body case 1 is threadedly connected with the upper portion of the flexible cup body 2.

A sealing ring 21 is provided between the lower portion of the body case 1 and the upper portion of the flexible cup body 2.

The flexible cup body 2 can be made of rubber or silica gel.

The flexible negative pressure cup further comprises a hand support 8 connected with the body case 1, which is convenient for grasping the flexible negative pressure cup while using.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A flexible negative pressure cup, comprising:
a body case having a boxlike shape and an air hole provided on a bottom wall of said body case; a flexible cup body; an air extracting pump; an inlet valve; a control box; and a flexible tube,
wherein a lower portion of said body case is connected with an upper portion of said flexible cup body for forming an air chamber between said bottom wall of said body case and said flexible cup body,
wherein a middle portion of a bottom of said flexible cup body is upwardly protruded,
wherein two downwardly protruded annular buds are respectively formed at two end portions of said bottom of said flexible cup body,
wherein said air hole is communicated with said air extracting pump and said inlet valve which are located outside said body case by said flexible tube,
wherein said control box is connected with said air extracting pump and said inlet valve.

2. The flexible negative pressure cup, as recited in claim 1, wherein said lower portion of said body case is threadedly connected with said upper portion of said flexible cup body.

3. The flexible negative pressure cup, as recited in claim 1, wherein a sealing ring is provided between said lower portion of said body case and said upper portion of said flexible cup body.

4. The flexible negative pressure cup, as recited in claim 2, wherein a sealing ring is provided between said lower portion of said body case and said upper portion of said flexible cup body.

5. The flexible negative pressure cup, as recited in claim 1, wherein said flexible cup body is made of rubber or silica gel.

6. The flexible negative pressure cup, as recited in claim 2, wherein said flexible cup body is made of rubber or silica gel.

7. The flexible negative pressure cup, as recited in claim 3, wherein said flexible cup body is made of rubber or silica gel.

8. The flexible negative pressure cup, as recited in claim 4, wherein said flexible cup body is made of rubber or silica gel.

9. The flexible negative pressure cup, as recited in claim 1, further comprising a hand support connected with said body case which is convenient for grasping said flexible negative pressure cup while using.

10. The flexible negative pressure cup, as recited in claim 2, further comprising a hand support connected with said body case which is convenient for grasping said flexible negative pressure cup while using.

11. The flexible negative pressure cup, as recited in claim 3, further comprising a hand support connected with said body case which is convenient for grasping said flexible negative pressure cup while using.

12. The flexible negative pressure cup, as recited in claim 4, further comprising a hand support connected with said body case which is convenient for grasping said flexible negative pressure cup while using.

13. The flexible negative pressure cup, as recited in claim 5, further comprising a hand support connected with said body case which is convenient for grasping said flexible negative pressure cup while using.

14. The flexible negative pressure cup, as recited in claim 6, further comprising a hand support connected with said body case which is convenient for grasping said flexible negative pressure cup while using.

15. The flexible negative pressure cup, as recited in claim 7, further comprising a hand support connected with said body case which is convenient for grasping said flexible negative pressure cup while using.

16. The flexible negative pressure cup, as recited in claim 8, further comprising a hand support connected with said body case which is convenient for grasping said flexible negative pressure cup while using.
